(19) United States
(12) Patent Application Publication
(10) Pub. No.: US 2008/0270521 A1
(43) Pub. Date: Oct. 30, 2008

(54) Method and System for Coordinating Auxiliary Data Content Entry Into Service Requests

(76) Inventors: Jinmei Shen, Rochester, MN (US); Hao Wang, Rochester, MN (US)

Correspondence Address: IBM CORPORATION, 3605 HIGHWAY 52 NORTH, DEPT 917, ROCHESTER, MN, 55901-7829, US

(21) Appl. No.: 11/739,855

(22) Filed: Apr. 25, 2007

(51) Int. Cl. G06F 15/16

(52) U.S. Cl. 709/203

(57) ABSTRACT

A system and method for handling client service requests. In one embodiment, a client service request containing a content request directive and request context data is received at a server-side client interface. A request callback object containing the content request directive and the request context is generated. The callback object is issued to a connection agent that interfaces an auxiliary content channel and a transaction service. Responsive to the connection agent receiving the callback object, an asynchronous service request comprising the content request directive is issued to the transaction service and the callback object is registered with the auxiliary content channel. The auxiliary content channel retrieves auxiliary content that has been selected and prioritized in accordance with the request content. The retrieved auxiliary content is sent during servicing of the asynchronous service request by the transaction service. Responsive to retrieval of data satisfying the content request directive, the sending of retrieved auxiliary content is suspending and the data satisfying the content request directive is sent to the server-side client interface.

### BACKGROUND OF THE INVENTION

1. Technical Field

The present invention relates generally to handling client requests in a client server system, and in particular to coordinating processing of service request content and auxiliary response data.

2. Description of the Related Art

As use of the World Wide Web (WWW) and other large-scale online computer services becomes more pervasive, Internet-based advertising has become lucrative. Many of the advertisements now use attention-getting techniques such as animation, sounds, bright colors, etc. Typically, the advertisements are displayed in conjunction with content, such as web pages, requested by end-users. For example, if a user requests a certain web page, the web server will often dynamically generate a markup-language page to serve in response to the request by combining references to one or more advertisements with the content that the user requested. Advertising and other types of inserted supplemental or auxiliary content are generally delivered in the form of Uniform Resource Identifier (URI) references within markup language. As is well known, a Uniform Resource Locator (URL) is a specific type of URI. An example of a typical HTML image tag, containing a URI reference to supplemental content, is the reference <img src=“www.advertising-server.com/auxiliary-content.gif”>.

Typically, the web server serves the markup language document containing such references to the client, and it is the responsibility of the client to request any referenced supplemental content. This is commonly done during the client browser's rendering operation by making a separate request to each web server hosting the supplemental content. Unfortunately, such content can be extremely distracting and annoying to the end-user. This is especially the case since the supplemental content is usually unsolicited. Moreover, supplemental content with advanced features such as animation and sound can consume resources and slow the loading of the pertinent parts of the web page on the client.

Unsolicited advertisements inserted into desired content may often be found on web portal pages. As known, a portal page is generated at a web “portal” server by portal server software (e.g., WebSphere Portal Server, which is commercially available from International Business Machines Corp. of Armonk, N.Y.). A portal page typically includes sections or visual portlets that each contains certain content formatted according to a user's preferences. For example, a user could establish his/her own portal page that has sections for news, weather and sports. When the portal page is requested, the portal server would obtain the desired content from the appropriate content providers. Once obtained, the content would be aggregated and URI references to advertisements and other supplemental content inserted into the markup language for display in the appropriate sections as a portal web page. This portal technology has lead to the explosion of personalized “home” pages for individual web users.

In general, unsolicited auxiliary data such as contained in advertisements annoys users and many filtering and other techniques have been developed for obscuring or otherwise managing display of such content. For example, many products have been developed for simply blocking unwanted supplemental content. These products, sometimes called “ad blockers,” are usually conditioned upon regular expression matching against a list of Uniform Resource Identifier (URI) patterns representing known sources of content to be blocked. The list may also be referred to as a “block list.” Once such content is detected, the current ad blockers either do not retrieve the content referenced by the URI, or retrieve but do not render the content. In either case, the web page displayed to the user may be distorted from what the web designer intended, since the missing content could leave gaps or affect the layout and spacing of the remaining content. Further, if entries in the block list are incorrect, the ad blocker may incorrectly block valid, desired content. This could prevent pertinent content from reaching the users. Even worse, it could prevent a user from ever realizing that pertinent content has been blocked, making it impossible for the user to know that the block list needs to be corrected, and potentially seriously reducing the quality of the web browsing experience.

In view of the foregoing, there exists a need for a method, system and program product for improving handling of supplemental server-provided content such as advertisements. The present invention addresses this and other needs unresolved by the prior art.

### SUMMARY OF THE INVENTION

A system and method for handling client service requests are disclosed herein. In one embodiment, a client service request containing a content request directive and request context data is received at a server-side client interface. A request callback object containing the content request directive and the request context is generated. The callback object is issued to a connection agent that interfaces an auxiliary content channel and a transaction service. Responsive to the connection agent receiving the callback object, an asynchronous service request comprising the content request directive is issued to the transaction service and the callback object is registered with the auxiliary content channel. The auxiliary content channel retrieves auxiliary content that has been selected and prioritized in accordance with the request content. The retrieved auxiliary content is sent during servicing of the asynchronous service request by the transaction service. Responsive to retrieval of data satisfying the content request directive, the sending of retrieved auxiliary content is suspending and the data satisfying the content request directive is sent to the server-side client interface.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a high-level block diagram illustrating a client server network architecture that may be adapted to implement service request handling in accordance with the invention;

FIG. 2 is a block diagram depicting a data processing system that may be implemented as a server in accordance with a preferred embodiment of the present invention;

FIG. 3 is a block diagram illustrating a data processing system in which the present invention may be implemented;

FIG. 4 is a block diagram depicting a service request handling system in accordance with one embodiment of the present invention;

FIG. 5 is a high-level flow diagram illustrating bridge engine processing of a client service request in accordance with the present invention; and

FIG. 6 is a high-level flow diagram depicting further details of service request handling in accordance with the present invention.

### DETAILED DESCRIPTION OF ILLUSTRATIVE EMBODIMENT(S)

The present invention is directed to addressing problems associated with auxiliary content, such as advertisements included in web page responses, and particularly addresses the parallel delivery of auxiliary content with requested content. Simultaneous delivery and receipt of such auxiliary content results is largely responsible for delays and interruptions in receipt and displayed of requested content. In one aspect, the present invention is directed to a service request handling system that includes a synchronous-asynchronous-synchronous (SAS) bridge engine that includes a server-side interface which receives client services requests specifying content request directives as well as request context data. The SAS bridge engine includes program modules and instructions that generate a callback object that holds client service request data and may be handled asynchronously by a transaction service and an auxiliary content provider. As explained in further detail below, the callback object is utilized by a connection agent to send auxiliary content to the server-side interface and on to the client during pendency of processing of the content request directive for a given client request and halting the auxiliary content upon retrieval of data satisfying the content request directive.

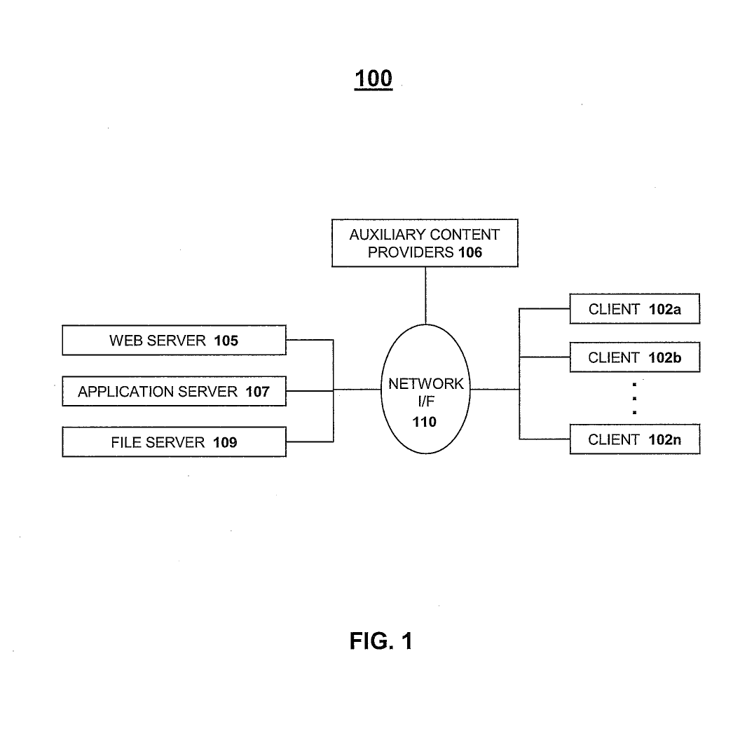

The present invention is preferably implemented in a client-server network architecture that separates requester or master side (i.e. client side) functionality from a service or slave side (i.e. server side functionality). FIG. 1 illustrates a network environment applicable to the present invention in which multiple requesters or client nodes 102a-102n are connected to a web server 105, an application server 107, and a file server 109 via a network interface 110. Requesters such as client nodes 102a-102n send service requests to service applications within servers 105, 107, and 109 over network 110. Examples of the network types that may be embodied by network 110 include, but are not limited to, wide-area networks (WANs) such as the Internet, and local area networks (LANs).

The hardware architectures underlying servers 105, 107, and 109 may include, but are not limited to, products such as are sold by IBM under the trademarks S/390 SYSPLEX, SP2, or RS6000 systems. Client applications running on clients 102a-102n often includes a graphical user interface, such as provided by a web browser, which enables a user to enter service requests to be sent to and processed by a server application. Typical of requests from clients 102a-102n to be handled by any of service applications with servers 105, 107, and 109 may be service requests including web page accesses, remote file transfers, electronic mail, and transaction support. Among the service applications provided by servers 105, 107, and 109 may be web-page servers, file servers, terminal servers, and mail servers.

Also logically coupled to servers 105, 107, and 109 as well as clients 102a-102n via network 110 is a set of auxiliary content providers 106. In the depicted embodiment, auxiliary content providers 106 collectively represents a variety of possible configurations internal or external to servers 105, 107, and 109 for supplementing service content responses with auxiliary or supplemental content, such as advertising content. Auxiliary content providers 106 may comprise server systems that place advertisements on web sites/pages. Such advertisement serving may include providing program and data software to web sites, including advertising sites, for serving advertisements and tracking statistical and other data relating to serving of the advertisements to determine profitability, for example.

Auxiliary content providers 106 may include a central advertisement server that stores and delivers advertisement content to website requesters (i.e., clients). In one embodiment, the central advertisement server within auxiliary content providers 106 may include a local and/or remote advertisement server. If local, the advertisement server is typically operated by a single publisher and serves advertisement content to that publisher's domains, enabling highly customized formatting and content management by the publisher. If remote, the advertisement server serves advertisement content across domains owned by multiple publishers. The advertisements are preferably delivered from a central source so that advertisers and publishers can track distribution of online advertisements and centrally manage the distribution of the advertisements across the web.

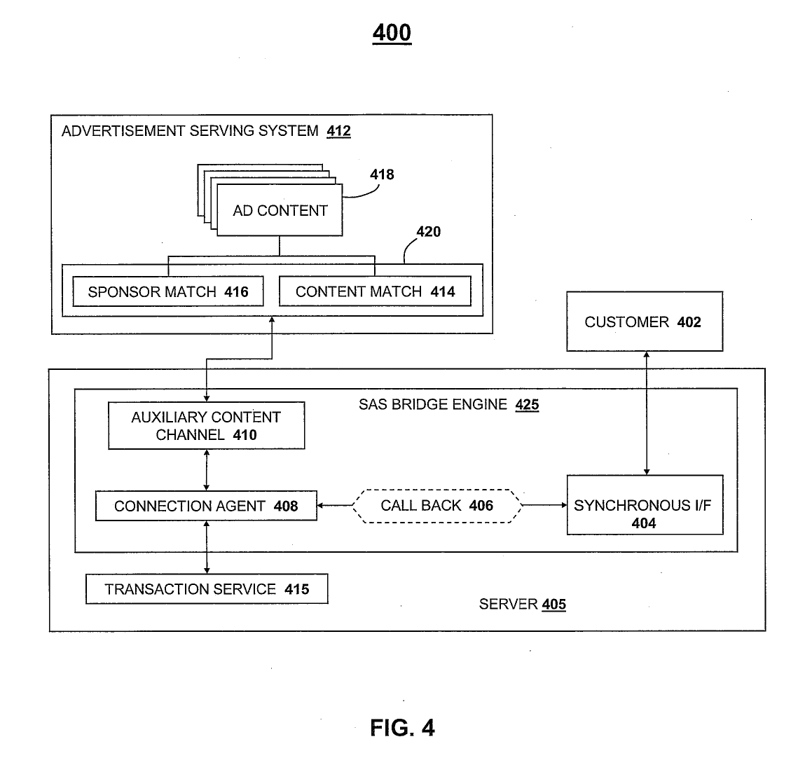

Auxiliary content providers 106 preferably include data and program modules and instructions for providing automated and semi-automated management of the content and distribution of advertisements such as for optimizing advertising placement, targeting, bid prices, etc. Generally, such advertisement management functionality comprises behavioral targeting, context targeting, and other content and distribution optimizations. As part of behavioral targeting, auxiliary content providers 106 may include logic and program modules and instructions for using prior behavior pattern data to select which advertisement to deliver during a given website visit. Auxiliary content provider 106 may also include logic and program modules for performing contextual targeting in which optimal advertisement placement is inferred from data generated in satisfaction of a client request (i.e., requested content). As depicted and explained in further detail below with reference to FIG. 4, the present invention provides a double bridge engine that leverages extant advertisement management and tracking functions such as those provided by auxiliary content providers 106 to efficiently integrate advertisement data insertion into client node responses from servers such as servers 105, 107, and 109.

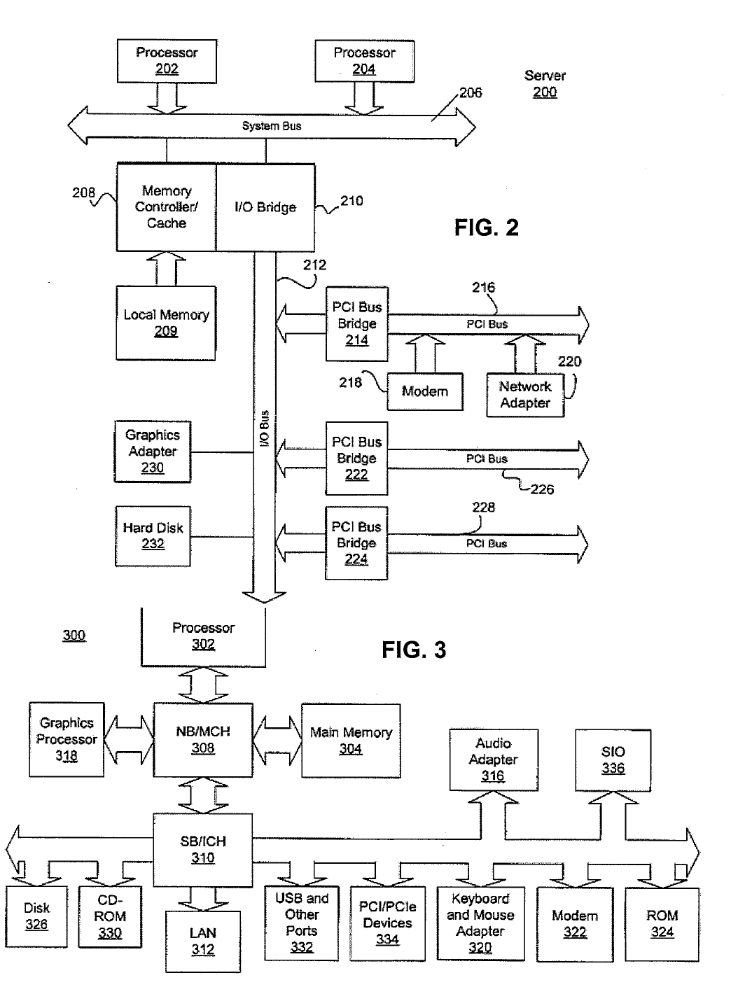

Referring to FIG. 2, there is illustrated a block diagram of a server system 200 that may be implemented as one or more of servers 105, 107, and/or 109 in FIG. 1, in accordance with the invention. Server system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

A peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to client nodes 102a-102n in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX™) operating system or LINUX operating system.

With reference now to FIG. 3, a block diagram of a data processing system is shown in which features of the present invention may be implemented. Data processing system 300 is an example of a computer, such as one of server nodes 105, 107, and/or 109 and/or one or more of client node 102a-102n in FIG. 1, in which code or instructions implementing the processes of the present invention may be stored and executed. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, LAN adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash basic input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300. The operating system may be a commercially available operating system such as AIX®. An object oriented programming system, such as the Java® programming system, may run in conjunction with the operating system and provides calls to the operating system from Java® programs or applications executing on data processing system 300.

Instructions for the operating system, the object-oriented programming system, and applications or programs are located on storage devices, such as hard disk drive 326, and may be loaded into main memory 304 for execution by processor 302. The processes of the present invention may be performed by processor 302 using computer implemented instructions, which may be stored and loaded from a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system such as that described with reference to FIG. 2.

Data processing system 300 may be a personal digital assistant (PDA), which is configured with flash memory to provide non-volatile memory for storing operating system files and/or user-generated data. The depicted example in FIG. 3 and above-described examples are not meant to imply architectural limitations. For example, data processing system 300 also may be a tablet computer, laptop computer, or telephone device in addition to taking the form of a PDA.

With reference to FIG. 4, there is illustrated a block diagram depicting a service request handling system 400 in accordance with one embodiment of the present invention. As shown in FIG. 4, service request handling system 400 generally comprises a server 405 having a synchronous-asynchronous-synchronous (SAS) bridge engine 425 that services client requests such as may be received from a customer node 402 as well as other client nodes. SAS bridge engine 425 includes client request processing modules that enable auxiliary content, such as advertisement content, to be issued in a manner minimally intrusive to the delivery and display of client requested content.

In the depicted embodiment, SAS bridge engine 425 includes a synchronous network interface 404 such as may be implemented by a network interface card that receives client service requests from customer node 402 over a network (not depicted) and which is the interface point across which corresponding service responses are delivered to customer node 402. Encapsulated in a typical client service request, such as a webpage request, is a content request directive that specifies the object of the client request/call. The content request directive for a webpage request includes the address of the requested page, for example. Server 405 further includes a transaction service module 415, such as a webpage server service, that directly addresses the content request directive such as by retrieving the content of the requested webpage to be delivered to customer node 402.

In addition to the content request directive, client service requests from customer node 402 typically include request context data. Such request context data is generally characterized as describing, identifying or in some manner characterizing the context framing the content request directive such as it may relate to the human requestor, the requesting node, or the content request itself. Such context data may therefore include behavioral pattern data such as may be collected and tracked with respect to a specified user or node relating to website visited, data accessed, etc. Such context data is often utilized to make more informed targeted advertising decisions.

The request context data is processed within SAS bridge engine 425 using an auxiliary content channel 410 which is communicatively coupled to an advertisement serving system 412. Auxiliary content channel 410 uses various request context data such as website history data and data secondarily derived from such history such as used to build a user profile, to selectively pass auxiliary data into responses from server 405 to clients such as customer node 402. In FIG. 4, such auxiliary data is contained and managed within advertisement serving system 412 which includes advertising content 418 and an auxiliary content miner 420. Advertising content 418 represents advertising data and other types of inserted supplemental or auxiliary content which are generally delivered in the form of Uniform Resource Identifier (URI) references within markup language. An example of a typical HTML image tag, containing a URI reference to supplemental content, is the reference <img src=“www.advertising-server.com/auxiliary-content.gif”>. It should be noted that auxiliary or supplemental content as used herein, and represented in FIG. 4 as advertisement content 418, may also refer to downloaded fonts, Javascript, Java bytecodes, ActiveX controls, markup language fragments, streaming media, Flash animations, or generally any other type of content that can be embedded in markup language by reference.

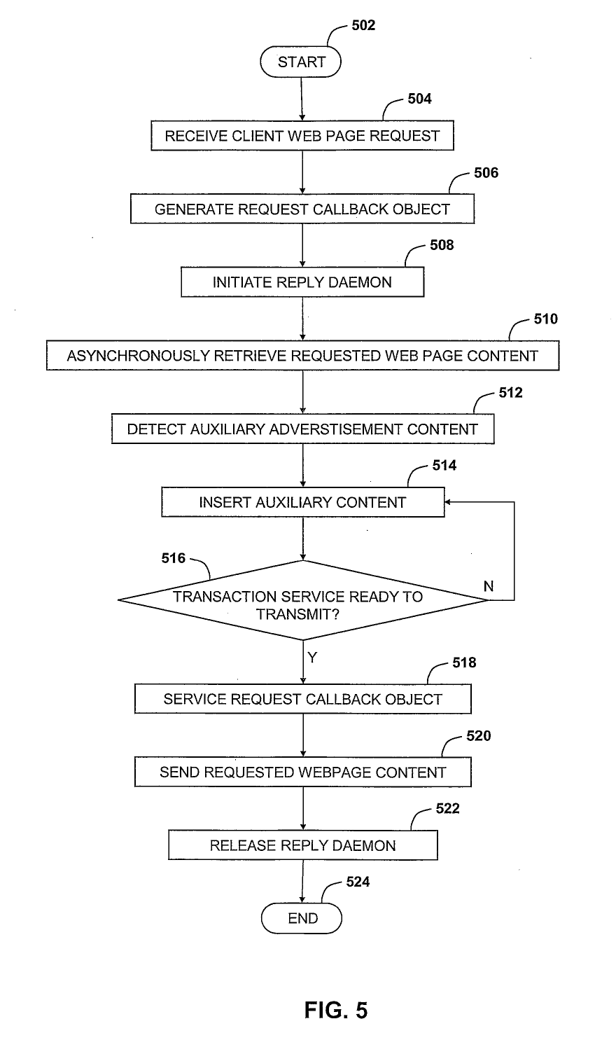

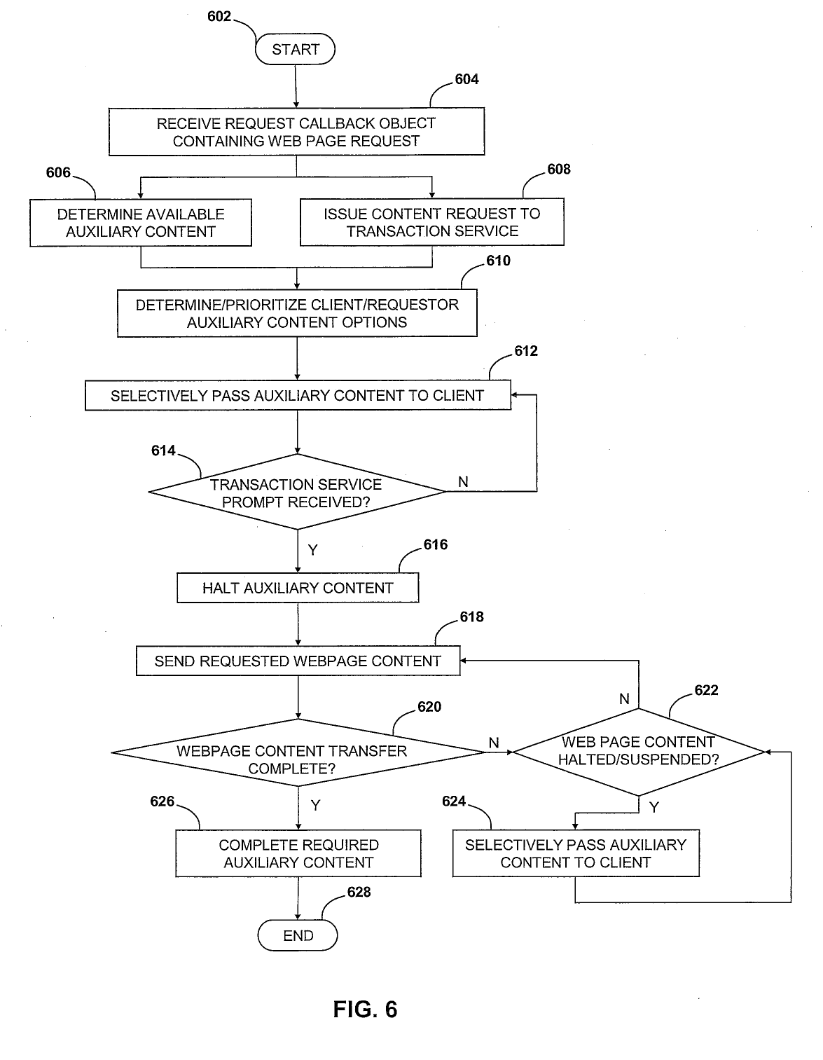

As depicted and explained with reference to FIGS. 5 and 6 in conjunction with FIG. 4, SAS bridge engine 425 further includes logic and program modules and instructions for addressing problems associated with collecting and delivering auxiliary content in association with satisfying the content request. Referring first to FIG. 5 in conjunction with FIG. 4, there is depicted a flow diagram illustrating bridge engine processing of a client service request received by server 405 in accordance with the present invention. The process begins as shown at steps 502 and 504 with the webpage request being received at synchronous network interface 404 which reads/parses the request and in response thereto, generates a callback object 406 as illustrated at step 506.

Callback object 406 contains the content request directive and request context data included in the client service request and is passed to a connection agent module 408 which initiates a service request reply daemon in association with callback object 406 as illustrated at step 508. The replay daemon places an effective hold on sending content requested in the content request directive portion of the service request and continuously monitors the status of content request processing performed by transaction service 415. Upon receiving callback object 406 and initiating the request replay daemon, connection agent 408 registers callback object 406 with auxiliary content channel 410 and issues the content request directive to transaction service 415. The daemon-tracked hold placed on sending content requested in the content request directive portion of the service request results in transaction service 415 retrieving the requested webpage content in an asynchronous manner with respect to other parts of the request session, and in particular with respect to sending auxiliary (i.e., non-requested) content (step 510).

Auxiliary content channel 410 is communicatively coupled to an auxiliary content miner module 420 within advertisement serving system 412. Auxiliary content miner 420 comprises content search/filter modules in the form of a sponsor match module 416 and a content match module 414. In association with registering callback object 406, auxiliary content channel 410 receives and utilizes the request context data included in callback object 406 to retrieve advertisement content from content miner module 420 and insert the retrieved content into callback object 406 to be sent back to customer 402 (step 514). Specifically, auxiliary content channel 410 reads and, if necessary, translates the context data which is then used by sponsor match module 416 and content match module 420 to identify and select advertising content that in a prioritized manner in accordance with user/client/request specific context data. In this manner, the selected, prioritized advertising content is delivered synchronously with respect to request session processing pending processing of the content request by transaction service 415.

As illustrated at steps 516 and 514, the sending of selected auxiliary content continues until the request reply daemon is signaled by transaction service 415 that the requested content has been retrieved in accordance with the content request directive and is ready to be sent to the requesting customer 402. In an alternate embodiment, retrieval of the requested content by transaction service 415 may be estimated such as by using a gap prediction mechanism implemented by connection agent 408 in which for a previous number of one or more similar client request transactions, the time period for processing a content request directive is recorded. An average response time may be computed from the recorded transaction time periods and utilized as the estimate of the time required for transaction service 415 to process a next content request directive. The gap prediction estimate of when transaction service processing terminates may preferably be utilized to adaptively adjust the period over which auxiliary content is sent such as for client requests having longer than expected response times.

Upon receiving an indication from transaction service 415 such as via the request reply daemon or by a timer set by connection agent 406 using gap prediction that data requested in the content request directive has been located and is ready to send, connection manager 408 sends the retrieved webpage content to customer 402 via synchronous interface 404 as depicted at steps 518 and 520. The client request session concludes with the daemon being released process ends as shown at steps 522 and 524.

Referring now to FIG. 6 in conjunction with FIG. 4, there is illustrated a high-level flow diagram depicting further details of service request handling such as performed by connection agent 408 and auxiliary content channel 410 in accordance with the present invention. The depicted process begins as shown at steps 602 and 604 with connection agent 408 receiving callback request object 406, which as mentioned above, contains the content request directive and request context data of the received webpage request. Responsive to receiving callback request object 406, connection agent 408 issues the encoded content request to transaction service 415 (step 608).

Also, and in cooperation with auxiliary data miner 420, auxiliary content channel 410 determines auxiliary content that is eligible to be sent to customer 402 as part of the server response as shown at step 606. The identification/determination of auxiliary content shown at step 606 preferably includes extracting user request context contained in the request context data contained in the original client service request. Auxiliary data miner 420 utilizes matching engines 416 and 414 to make target decisions as to the appropriate auxiliary content to extract from advertisement content 418 to provide a more user-targeted and request-targeted response.

Next, auxiliary content channel 410 selectively prioritizes the eligible advertisement content (step 610) to be passed via callback object 406 to customer 402 (step 612). In one embodiment, such prioritization includes first identifying and categorizing advertising content that is “required” from optional advertising content. Second, the prioritization entails sequentially prioritizing the optional advertising content so that the most important among the optional content is sent earlier. The required/optional categorization is utilized to sequentially issue, in accordance with available bandwidth, the advertising content beginning as shown at step 612.

As illustrated at steps 614 and 612, auxiliary content channel 410 and connection agent 408 continue to pass the selected, categorically prioritized advertising to customer 402 via synchronous interface 404 during retrieval of webpage content by transaction service 415. Responsive to receiving a signal from transaction service 415 indicating that the webpage content has been retrieved and is ready to send, connection agent 408 halts sending the advertising content (step 616) and begins sending the requested webpage content (step 618). The halting or suspension of auxiliary content at step 616 may be imposed responsive to a transaction service signal or by a close connection timer such as implemented by the gap prediction mechanism previously described for a continuous request stream. The webpage content transfer continues until the content request has been satisfied (step 620). Following transfer of the webpage content in satisfaction of the content request directive, connection agent completes sending advertising content categorized at step 610 as required (step 626).

If due to input/output (I/O) management or otherwise, the webpage content transfer shown at step 618 is temporarily suspended before completion (step 622), connection agent 408 restarts the request reply daemon and again commences sending the prioritized advertising content during the suspended state of transaction service 415 (step 624). The request reply daemon again detects when transaction service 415 is ready to continue sending the requested data at which point the process passes back to step 620 and ends as shown at step 628.

The previously described systems and methods enable more convenient and efficient administration of auxiliary content due to the logical and temporal separation of the content and auxiliary content data streams. In this manner, the present invention provides a more user friendly and targeted service request response mechanism that integrates auxiliary content and requested content using the SAS bridge that coordinates two distinct processing streams in the service request processing loop.

The disclosed methods may be readily implemented in software using object or object-oriented software development environments that provide portable source code that can be used on a variety of computer or workstation hardware platforms. In this instance, the methods and systems of the invention can be implemented as a routine embedded on a personal computer such as a Java or CGI script, as a resource residing on a server or graphics workstation, as a routine embedded in a dedicated source code editor management system, or the like.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. A method for handling client service requests comprising:
receiving a client service request at a server-side client interface, said client service request containing a content request directive and request context data;
responsive to receiving said client service request, generating a request callback object containing the content request directive and the request context;
issuing said callback object to a connection agent that interfaces an auxiliary content channel and a transaction service;
responsive to the connection agent receiving the callback object:
issuing an asynchronous service request comprising the content request directive to be serviced by the transaction service; and
registering said callback object with said auxiliary content channel;
utilizing the auxiliary content channel to retrieve auxiliary content in accordance with the request context data; and
sending the retrieved auxiliary content to the server-side client interface during servicing of the asynchronous service request by the transaction service;
responsive to retrieval by the transaction service of data satisfying the content request directive:
suspending said sending the retrieved auxiliary content; and
sending the data satisfying the content request directive to the server-side client interface.

2. The method of claim 1, further comprising, responsive to the connection agent receiving the callback object, initiating a service request reply daemon that monitors processing of the content request directive by said transaction service.

3. The method of claim 2, wherein said sending of said retrieved auxiliary content is suspended in response to said daemon detecting a reply response from said transaction service.

4. The method of claim 1, further comprising:
tracking time periods required for processing content request directives for multiple client service requests; and
determining an average time period for responding to a content request directive from said tracked time periods.

5. The method of claim 4, further comprising:
in response to said issuing an asynchronous service request comprising the content request directive to be serviced by the transaction service, starting a timer; and
suspending said sending the retrieved auxiliary content in response to said average time period lapsing.

6. The method of claim 1, wherein said utilizing the auxiliary content channel to retrieve auxiliary content in accordance with the request context data comprises categorizing auxiliary content as either required or optional in accordance with the request context data.

7. A system for handling client service requests comprising:
a server interface that receives a client service request at a server-side client interface, said client service request containing a content request directive and request context data, wherein responsive to receiving said client service request, said server interface generates a request callback object containing the content request directive and the request context;
a connection agent that receives said callback object and interfaces an auxiliary content channel and a transaction service, wherein in responsive to receiving the callback object the connection agent:
issues an asynchronous service request comprising the content request directive to be serviced by the transaction service; and
registers said callback object with said auxiliary content channel;
wherein the auxiliary content channel retrieves auxiliary content in accordance with the request context data; and
wherein the connection agent sends the retrieved auxiliary content to the server-side client interface during servicing of the asynchronous service request by the transaction service, and, responsive to retrieval by the transaction service of data satisfying the content request directive the connection agent:
suspends said sending the retrieved auxiliary content; and
sends the data satisfying the content request directive to the server-side client interface.

8. The system of claim 7, wherein responsive to receiving the callback object, said connection agent initiates a service request reply daemon that monitors processing of the content request directive by said transaction service.

9. The system of claim 8, wherein said connection agents suspends the sending of said retrieved auxiliary content in response to said daemon detecting a reply response from said transaction service.

10. The system of claim 7, wherein said connection agent further comprises:
a timer for tracking time periods required for processing content request directives for multiple client service requests; and
processing means for determining an average time period for responding to a content request directive from said tracked time periods.

11. The system of claim 10, wherein said connection manager starts a timer in response to said issuing an asynchronous service request, and suspends said sending the retrieved auxiliary content in response to said average time period lapsing.

12. The system of claim 7, wherein the auxiliary content channel categorizes auxiliary content as either required or optional in accordance with the request context data.

13. A tangible computer-readable medium having encoded thereon computer-executable instructions for handling client service requests, said computer-executable instructions adapted for performing a method comprising:
receiving a client service request at a server-side client interface, said client service request containing a content request directive and request context data;
responsive to receiving said client service request, generating a request callback object containing the content request directive and the request context;
issuing said callback object to a connection agent that interfaces an auxiliary content channel and a transaction service;
responsive to the connection agent receiving the callback object:
issuing an asynchronous service request comprising the content request directive to be serviced by the transaction service; and
registering said callback object with said auxiliary content channel;
utilizing the auxiliary content channel to retrieve auxiliary content in accordance with the request context data; and
sending the retrieved auxiliary content to the server-side client interface during servicing of the asynchronous service request by the transaction service;
responsive to retrieval by the transaction service of data satisfying the content request directive:
suspending said sending the retrieved auxiliary content; and
sending the data satisfying the content request directive to the server-side client interface.

14. The computer-readable medium of claim 13, wherein said method further comprises, responsive to the connection agent receiving the callback object, initiating a service request reply daemon that monitors processing of the content request directive by said transaction service.

15. The computer-readable medium of claim 14, wherein said sending of said retrieved auxiliary content is suspended in response to said daemon detecting a reply response from said transaction service.

16. The computer-readable medium of claim 13, wherein said method further comprises:
tracking time periods required for processing content request directives for multiple client service requests; and
determining an average time period for responding to a content request directive from said tracked time periods.

17. The computer-readable medium of claim 16, wherein said method further comprises:
in response to said issuing an asynchronous service request comprising the content request directive to be serviced by the transaction service, starting a timer; and
suspending said sending the retrieved auxiliary content in response to said average time period lapsing.

18. The computer-readable medium of claim 13, wherein said utilizing the auxiliary content channel to retrieve auxiliary content in accordance with the request context data comprises categorizing auxiliary content as either required or optional in accordance with the request context data.
